(19) United States
(12) Patent Application Publication
(10) Pub. No.: US 2009/0299520 A1
(43) Pub. Date: Dec. 3, 2009

(54) MONITORING DEVICE AND METHOD FOR MONITORING THE STATUS OF A CARGO CONTAINER

(76) Inventors: Carl Binding, Rueschlikon (CH); Francois Bernard Dolivo, Waedenswil (CH); Reto Joseph Hermann, Buttikon (CH); Dirk Huscmann, Einsiedeln (CH)

Correspondence Address: ANNE VACHON DOUGHERTY, 3173 CEDAR ROAD, YORKTOWN HTS., NY, 10598, US

(21) Appl. No.: 12/302,920

(22) PCT Filed: May 3, 2007
(86) PCT No.: PCT/IB07/51656

§ 371 Date: Jun. 17, 2009

(30) Foreign Application Priority Data
May 30, 2006 (EP) 06114675.9

(51) Int. Cl. G06F 7/00; G01S 5/00

(52) U.S. Cl. 700/213; 342/357.07

(57) ABSTRACT

A monitoring device (10) attached to a cargo container, the monitoring device comprising a timer (28), a barometer (26), a controller (30), a positioning module (24) and a wireless communication module (32, 34, 36). The barometer (26) provides barometric pressure measurements at predetermined time intervals over a predetermined time window determined by the timer (28). The controller (30) processes the timed pressure measurements into a lift profile and then applies an algorithm to the lift profile to determine whether the cargo container has been loaded or unloaded onto or from a means of transport.

### TECHNICAL FIELD

This invention relates to the field of monitoring cargo containers and particularly relates to detection of loading events and unloading events for cargo containers onto and from means of transportation.

### BACKGROUND OF THE INVENTION

Cargo containers within the global container shipping network need to be identified, tracked and monitored throughout their journey, including when the containers are in storage at shipping ports. A key event in container journeys is the loading and unloading of the containers at shipping ports. Such loading and unloading events may be used to trigger associated business processes within the shipping companies.

It is known to track a cargo container across a global trade-lane using an active device attached to the cargo container which uses Global Positioning System GPS to detect the container position and a wireless communication means to periodically transmit the position of the container to a central controller. A problem associated with such active devices is their continuous power consumption, as there is an ongoing security requirement to know the location of the container when in storage and during journeys.

US Patent Application 2003/0193433 discloses a container tracking system comprising a dispatcher work-station with a graphical user interface and a database. These are used to track the whereabouts of shipping containers in storage and transfer yard. A mobile unit in the yard is attached to container handling equipment and monitors the lock-on mechanism. When a container is locked on for a move, the mobile unit starts reporting positions and velocities to the dispatcher workstation over a radio channel. These positions and solutions are computed from a combination of GPS satellite navigation receiver solutions, inertial navigation and local beacon markers. Reports stop when the container handling equipment unlocks from the container. The database then updates the new position for that container, and the graphical user interface can be used to “see” the container on a yard map. In such a container tracking system, no information on the position of the container is provided during the journey onboard a ship.

It is an aim of the present invention to provide a system for determining whether a container is in a loaded or unloaded state, and thereby being able to modify the mode of operation of a monitoring device to a suitable mode dependent upon whether the container is in a loaded or unloaded state. A further aim is to achieve this without construction of additional infrastructure.

### SUMMARY OF THE INVENTION

According to a first aspect of the present invention there is provided a monitoring device for a cargo container, the monitoring device comprising a timer, a barometer for providing barometric pressure measurements at predetermined time intervals over a predetermined time window determined by the timer, a controller for processing the timed pressure measurements to determine whether a loading/unloading event has occurred.

Preferably, the monitoring device further comprises a positioning module for determining whether the monitoring device is in a loading/unloading zone where it is allowable for a loading/unloading event to occur.

Further, the controller may be designed to transform the timed pressure measurements into a lift profile and then apply an algorithm to the lift profile to determine whether a loading/unloading event has occurred.

Preferably, the monitoring device further comprises a wireless communication module for communicating monitoring device data with a backend server via the internet. Wherein the wireless communication module may be a satellite transceiver, a cellular modem or a Wireless Personal Area Network module.

The operational mode of the monitoring device may be changed dependent upon whether a loading event or an unloading event has occurred. For example, where the operational mode is a loaded mode of operation, the monitoring device may be enabled to temporarily reduce monitoring activities. Alternatively, where the operational mode is a loaded mode of operation, the monitoring device may be enabled to distribute functionality utilizing services of the means of transport onto which the cargo container is loaded.

In a further embodiment the monitoring device may further comprise an accelerometer, a gyroscope, or other motion detector to obtain measurement data for the calculation of the lift profile.

Preferably, the positioning module is a Global Positioning System module.

According to a second aspect of the present invention there is provided a method for monitoring a cargo container to determine whether a loading/unloading event occurs, the method comprising obtaining barometric pressure measurements at predetermined time intervals over a predetermined time window, processing the timed pressure measurements to determine whether a loading/unloading event has occurred.

Preferably, the method further comprises providing location data to determine whether the cargo container is in a loading/unloading zone where it is allowable for a loading/unloading event to occur.

The method may further comprise processing the timed pressure measurements into a lift profile and then applying an algorithm to the lift profile to determine whether a loading/unloading event has occurred.

Further, the method may further comprise wirelessly communicating the loading/unloading event data obtained with a backend server via the internet.

According to a third aspect of the present invention there is provided a computer program product comprising a computer-readable medium embodying program instructions executable by at least one processor to perform the method according to the second aspect of the present invention.

### BRIEF DESCRIPTION OF THE FIGURES

Embodiments of the present invention will now be described, by way of examples only, with reference to the accompanying drawings in which:

FIG. 1 is an illustration of a monitoring device platform;

FIG. 2 is a block diagram of a monitoring device in accordance with the present invention;

FIGS. 3a and 3b show flow diagrams of the method of operation of a monitoring device in accordance with the present invention.

### DESCRIPTION OF PREFERRED EMBODIMENTS

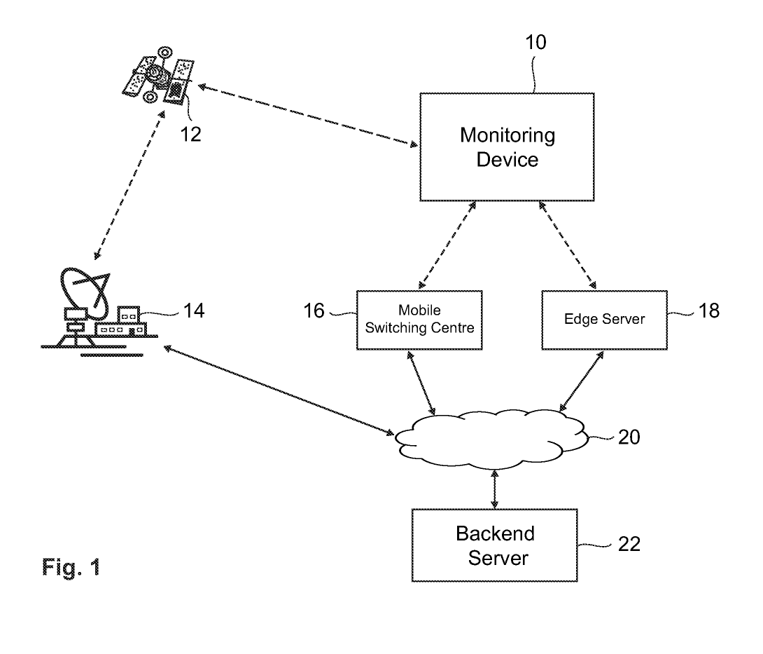

Referring first to FIG. 1, a monitoring device 10 may support communication over one or more types of communication network. Three types of communication networks are illustrated in FIG. 1, including a satellite communication network 12 14, a cellular communication network 16, for example GSM/GPRS General Packet Radio Service, and a Wireless Personal Area Network WPAN communication network 18, for example ZigBee/802.15.4. Each communication network provides internet 20 access to a backend infrastructure 22. The at least one communication network module integral to the monitoring device may also be known as a wireless communication module. The satellite communication network provides access over a satellite 12 and a landbased communication station 14, the cellular communication network provides access over a Mobile Switching Center MSC 16, and the WPAN communication network provides access over an edge server 18.

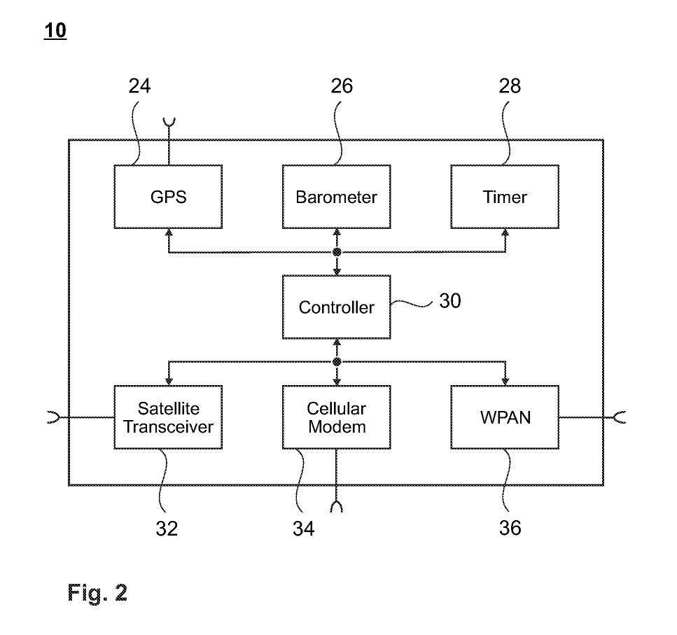

Turning to FIG. 2, the monitoring device 10 comprises a Global Positioning System GPS module 24, a barometer 26 and a timer 28, all connected to a controller 30. The monitoring 10 device further comprises at least one communication module. The communication modules of the present embodiment are a satellite transceiver 32, a cellular modem 34 and a WPAN radio 36; each connected to the controller 30. The role of the at least one communication module 32, 34, 36 is to monitor the GPS module and the barometer, and collect and process the data measured by them, and manage the communication to the backend infrastructure. The or each communication module 32, 34, 36 and also the GPS module 24 have an antenna. The GPS module may also be referred to as a positioning module. A battery, not illustrated, may be attached to the monitoring device 10 to power the operation of the monitoring device.

In operation, location data is determined by the GPS module 24 within the monitoring device 10 and periodically transmitted via the satellite 12 14, or cellular communication network 16, or the WPAN communication network 18 to the backend server 22. The monitoring device 10 further operates to automatically detect the loading and unloading of the container onto and from transportation means. Loading and unloading events can only happen in specific predetermined geographic zones, known as loading/unloading zones. For example, a loading/unloading zone may be the area within a shipping port where the cranes that load and unload containers onto and from ships are located. Specifically, when the monitoring device 10 determines that it is located within a loading/unloading zone, the monitoring device 10 activates the barometer 26 and collects samples of barometric pressure measurements, taken at regular time intervals over a predetermined time window determined by the timer 28.

The pressure measurements are processed by the controller 30. They are first transformed into a lift profile, i.e., the variation in height the monitoring device has experienced over the time window. A hypothesis testing algorithm is then applied to the lift profile to decide if it corresponds to a loading/unloading event. Where a loading/unloading event is determined to have taken place, this information is transmitted to the backend server 22.

The absolute barometric pressure at the loading/unloading zone can be considered to be constant over the time duration of a loading/unloading operation. Since the lift profile depends only on the difference in barometric pressures, it is independent of the absolute barometric pressure. The lift profile is also not affected by variation of the pressure due to changes in temperature since these happen at a too slow rate to have an influence during the time duration of a loading/unloading operation.

In the present invention, two alternative methods are presented for detecting whether the monitoring device is inside a known loading/unloading zone. In a preferred method, the monitoring device 10 has stored in a memory a set of loading/unloading zones relevant to the particular container journey. Each time the GPS module 24 determines an updated location, a process is run on the controller 30 to determine if this new location is inside one of the stored loading/unloading zones. In an alternative method, the controller in the monitoring device can send each updated location to the backend server over one of the communication channels, whereupon the backend server 22 checks if that location is within one of the loading/unloading zones stored in a database of the backend server and sends back the result to the monitoring device. In this second method, the monitoring device has to communicate with the backend server 22 each time a new position is acquired from the GPS module.

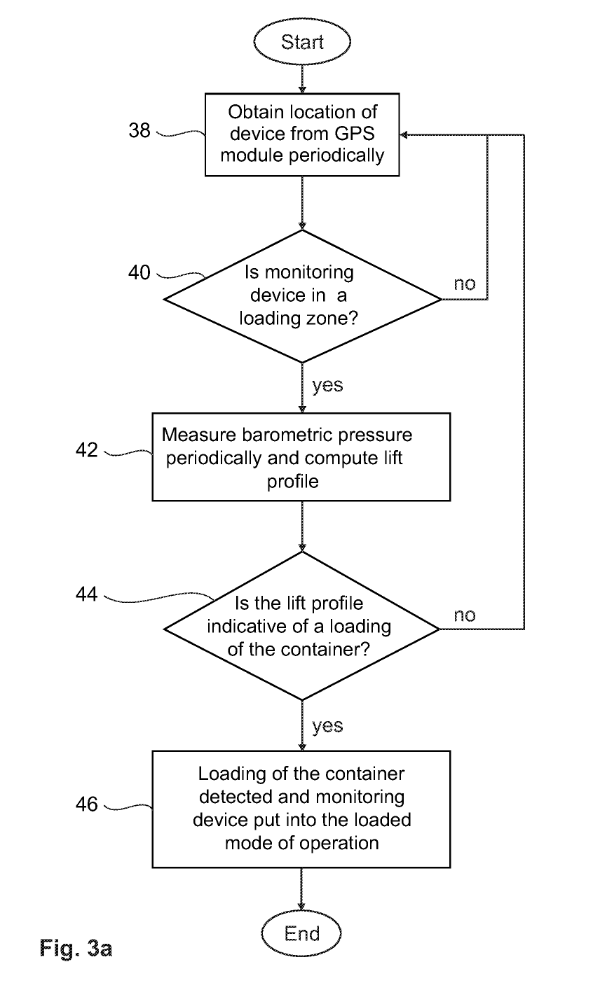

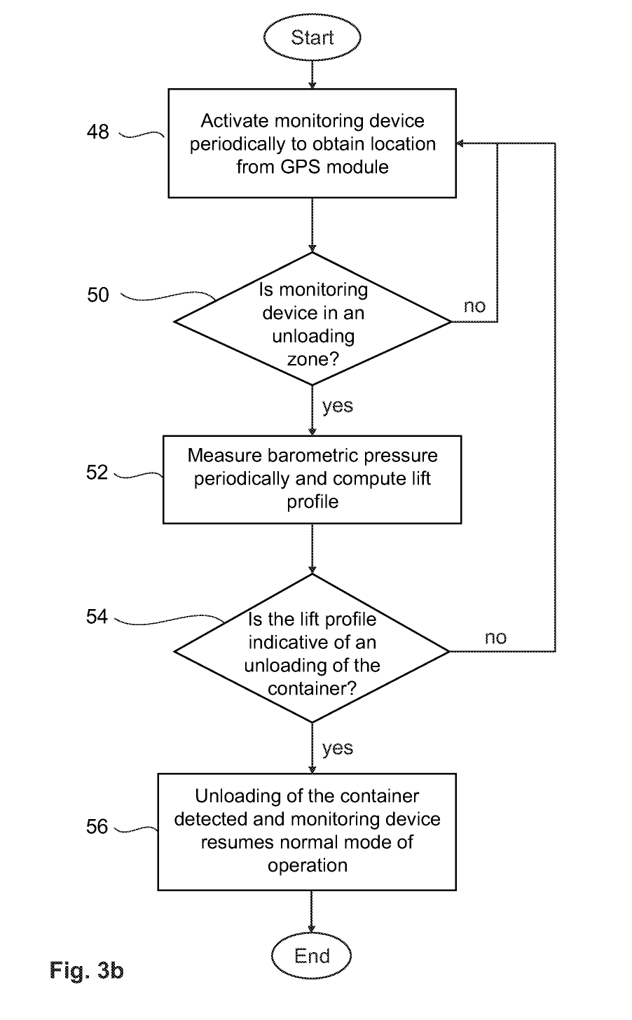

FIG. 3a shows a flow diagram of the method of operation of a monitoring device of the present invention for the detection of a loading event. For this instance, it is assumed that the monitoring device is initially in a normal mode of operation and in an unloaded condition. In an initial step in the detection of a loading event, location data is periodically obtained 38 by the GPS module within the monitoring device. Next, it is determined 40 whether the monitoring device 10 is in a known loading zone. If this is not the case, then the GPS module continues to periodically obtain location data. If the monitoring device 10 is in a loading zone, then the barometer 26 and the timer 28 are used to periodically measure 42 and record barometric pressure samples over a pre-determined time window. The set of pressure samples are transformed into a lift profile. The monitoring device uses the hypothesis testing algorithm to decide 44 whether the lift profile is indicative of a loading event. If the lift profile is not indicative of a loading event then the monitoring device 10 again returns to step 38. When loading of the container is detected 46, the monitoring device can notify the backend server 22 about this event and the monitoring device 10 may then activate the loaded mode of operation.

FIG. 3b shows a flow diagram of the method of operation of a monitoring device 10 of the present invention for the detection of an unloading event. For this instance, it is assumed that the monitoring device is initially in a loaded mode of operation and in a loaded condition. In an initial step in the detection of an unloading event, the monitoring device is periodically activated 48 to obtain a location data from the GPS module 24. Next, it is determined 50 whether the monitoring device is in a known unloading zone. If this is not the case, then the GPS module continues to be periodically activated to obtain location data. If the monitoring device 10 is in a known unloading zone, the barometer 26 and the timer 28 are used to periodically measure 52 and record barometric pressure samples over a pre-determined time window. The set of pressure samples are computed and transformed into a lift profile. The monitoring device 10 uses the hypothesis testing algorithm to decide 54 whether the lift profile is indicative of an unloading event. If the lift profile is not indicative of an unloading event then the monitoring device 10 again returns to step 48. When unloading of the container is determined 56, the monitoring device can notify the backend server 22 about this event and the monitoring device 10 may then resume normal mode of operation.

Additionally, the GPS module 24 may be utilized to provide a determination of two-dimensional speed of the monitoring device when a loading event or an unloading event is sensed, in order to confirm that the cargo container has not simply been raised and lowered in the same position. Further, additional data describing the expected date and time of a loading or unloading event of the tracked cargo container may be transmitted to the monitoring device 10. Through an automatic comparison with the actual date and time of changes recorded in barometer pressure, a further check can be made as to whether those changes equate to an expected loading or unloading event. This check further ensures the security of the cargo container.

Thus, the accurate recording of container loading events and unloading events may be used to automatically change the mode of operation of the monitoring device. Once the loading of a container onto a ship has been detected, the monitoring device may then activate the loaded mode of operation. Dependent on the circumstances, the loaded mode of operation my take different forms. For example, because the container is then considered to be in a safe area, monitoring activities may be reduced to provide only the limited functionality needed for that safe environment. Further, communication with the backend server may be suspended, either because it is not required or not possible due to the location of the monitoring device. Advantageously, this loaded mode of operation reduces power consumption of the monitoring device and thus extends the monitoring device battery lifetime.

Alternatively, the loaded mode may involve communication of the monitoring device with edge servers provided by the ship and connected to the ship's infrastructure. The ship's edge servers include a WPAN radio that can be configured with the WPAN module 36 of the monitoring device 10 as a multi-hop mesh network. In this situation, detecting loading of the container onto the ship will trigger the monitoring device to establish a mesh network including the edge servers. The monitoring device, may then access the ship services (position information, satellite communication, etc.), enabling the monitoring device to obtain location data from the ship's positioning system and to use the ship's satellite communication system to communicate with the land-based backend infrastructure. Thus, in this loaded mode of operation, a monitoring device that does not have satellite visibility on the ship, for example, due to being located deep in the hull of the ship, can report the state of the containers to the backend server 22.

The present invention directly addresses the problem of providing a system for determining whether a container is in an loaded or unloaded state, and thereby being able to automatically modify the mode of operation of a monitoring device to a suitable mode dependent upon whether the container is in a loaded or unloaded state.

Further advantage is obtained in that this system may be implemented without construction of additional infrastructure. Standard wireless networks, such as a satellite communication network, a cellular communication network, for example GSM/GPRS, and a WPAN communication network, are used. A standard positioning system, such as GPS, is used.

The monitoring device of the present invention may be realized as hardware implemented functions or software implemented functions or as a combination of hardware and software implemented functions.

Improvements and modifications can be made to the foregoing without departing from the scope of the present invention. For example, the lift profile may include measurement data obtained from an accelerometer, a gyroscope, or other motion detector. The monitoring device may be permanently or temporarily attached to a cargo container.

1. A monitoring device for a cargo container, the monitoring device comprising:
a timer;
a barometer for providing barometric pressure measurements at predetermined time intervals over a predetermined time window determined by the timer; and
a controller for processing the timed pressure measurements to determine whether a loading/unloading event has occurred.

2. The monitoring device as claimed in claim 1, further comprising
a positioning module for determining whether the monitoring device is in a loading/unloading zone where it is allowable for a loading/unloading event to occur.

3. The monitoring device as claimed in claim 1, wherein the controller is designed to transform the timed pressure measurements into a lift profile and then apply an algorithm to the lift profile to determine whether a loading/unloading event has occurred.

4. The monitoring device as claimed in claim 1, further comprising
a wireless communication module for communicating monitoring device data with a backend server via the internet.

5. The monitoring device as claimed in claim 4, wherein the wireless communication module is a satellite transceiver, a cellular modem or a Wireless Personal Area Network module.

6. The monitoring device as claimed in claim 1, wherein an operational mode of the monitoring device is changed dependent upon whether a loading event or an unloading event has occurred.

7. The monitoring device as claimed in claim 6, wherein the operational mode is a loaded mode of operation thereby enabling the monitoring device to temporarily reduce monitoring activities.

8. The monitoring device as claimed in claim 6, wherein the operational mode is a loaded mode of operation thereby enabling the monitoring device to distribute functionality utilizing services of a means of transport onto which the cargo container is loaded.

9. The monitoring device as claimed in claim 1, wherein the monitoring device further comprises an accelerometer, a gyroscope, or other motion detector to obtain measurement data for calculation of the lift profile.

10. The monitoring device as claimed in claim 2, wherein the positioning module is a Global Positioning System module.

11. A method for monitoring a cargo container to determine whether a loading/unloading event occurs, the method comprising:
obtaining barometric pressure measurements at predetermined time intervals over a predetermined time window to obtain timed pressure measurements; and
processing the timed pressure measurements to determine whether a loading/unloading event has occurred.

12. The method as claimed in claim 11, further comprising
providing location data to determine whether the cargo container is in a loading/unloading zone where it is allowable for a loading/unloading event to occur.

13. The method as claimed in claim 11, further comprising
processing the timed pressure measurements into a lift profile and then applying an algorithm to the lift profile to determine whether a loading/unloading event has occurred.

14. The method as claimed in claim 11, further comprising:
wirelessly communicating the loading/unloading event data obtained with a backend server via the internet.

15. A computer program product comprising a computer-readable medium embodying program instructions executable by at least one processor to perform a method for monitoring a cargo container to determine whether a loading/unloading event occurs, comprising steps of:
obtaining barometric pressure measurements at predetermined time intervals over a predetermined time window to obtain timed pressure measurements; and
processing the timed pressure measurements to determine whether a loading/unloading event has occurred.
